(19) United States
(12) Patent Application Publication
(10) Pub. No.: US 2015/0040858 A1
(43) Pub. Date: Feb. 12, 2015

(54) FUEL SYSTEM FOR AN INTERNAL COMBUSTION ENGINE

(71) Applicant: Electro-Motive Diesel, Inc., LaGrange, IL (US)

(72) Inventor: Rakesh Malhotra, Aurora, IL (US)

(73) Assignee: Electro-Motive Diesel, Inc., LaGrange, IL (US)

(21) Appl. No.: 13/963,082

(22) Filed: Aug. 9, 2013

(51) Int. Cl. F02M 21/02

(52) U.S. Cl. CPC F02M 21/0275; F02M 21/0284
USPC 123/299

(57) ABSTRACT

An improved fuel system for an internal combustion engine is disclosed. The fuel system includes an engine having at least one cylinder, comprising: a liquid fuel injector configured to inject liquid fuel into the at least one cylinder; and a gaseous fuel injector having a nozzle configured to inject gaseous fuel into at least one cylinder, wherein the gaseous fuel injector is positioned outside an airbox associated with at least one cylinder.

### TECHNICAL FIELD

This disclosure relates generally to a fuel system and more particularly to an improved fuel system for an internal combustion engine.

### BACKGROUND

Due to the rising costs of liquid fuel (e.g. diesel fuel) and ever increasing restrictions on exhaust emission, engine manufactures have developed dual-fuel engines. An exemplary dual-fuel engine provides a low-cost gaseous fuel (e.g. natural gas) through air intake ports of the engine's cylinders. The gaseous fuel is introduced with clean air that enters through the intake ports and is ignited by liquid fuel that is injected during each combustion cycle. Because a lower-cost fuel is used together with liquid fuel, cost efficiency may be improved. In addition, the combustion of the gaseous and liquid fuel mixture may result in a reduction of harmful emissions.

An example of this type of arrangement is disclosed in U.S. Pat. No. 4,527,516 to Foster. In particular, the '516 patent discloses a dual-fuel engine that includes an inlet pipe connected at one end to a gas source and at opposite end to the side of an engine via an inlet port. The pipe is held in the inlet port by a port seal, such that an upper edge of the pipe is spaced below an upper edge of the inlet port. The '516 patent also optionally includes an electronically controlled gas admission valve to control the timing of the gas entry into the cylinder via the inlet pipe. Additionally, typically, the gas fuel injector that supplies gas to the engine cylinder liner is located in close proximity to the cylinder liner. However, the cylinder liner is exposed to high temperature and pressure conditions during the combustion process and may cause the gaseous fuel injector to deteriorate.

The disclosed fuel system is directed at overcoming one or more problems of the prior art.

### SUMMARY

In one aspect of the present disclosure, an improved fuel system for an internal combustion engine is disclosed. The fuel system includes a liquid fuel injector configured to inject liquid fuel into at least one cylinder and a gaseous fuel injector having a nozzle configured to inject gaseous fuel into at least one cylinder. The gaseous fuel injector is positioned outside an airbox.

In another aspect of the present disclosure, an improved fuel system for an internal combustion engine is disclosed. The fuel system includes a gaseous fuel injector having a nozzle configured to inject gaseous fuel into at least one cylinder. The gaseous fuel injector is positioned outside an airbox.

### BRIEF DESCRIPTION OF DRAWINGS

FIG. 1 is a cross-sectional illustration of a dual-fuel engine equipped with an exemplary disclosed fuel system;

FIG. 2 is a pictorial illustration of an exemplary disclosed fuel injector that may be used in conjunction with the fuel system of FIG. 1;

FIG. 3 is a pictorial illustration of an exemplary disclosed fuel injector that may be used in conjunction with the fuel system of FIG. 1; and

FIG. 4 is a schematic illustration of an exemplary disclosed fuel system retrofit kit that may be used in conjunction with the fuel system of FIG. 1.

### DETAILED DESCRIPTION

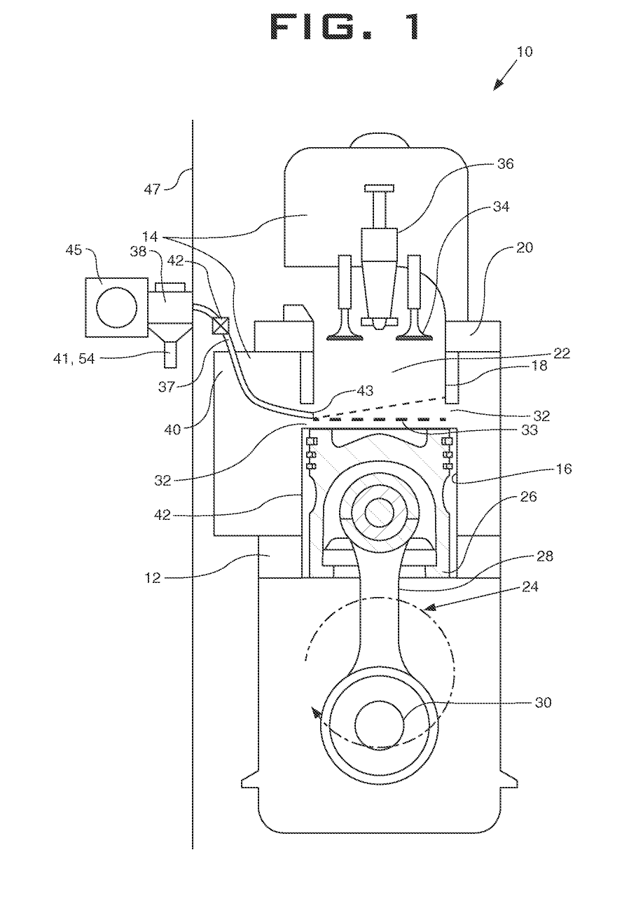

FIG. 1 illustrates an exemplary internal combustion engine 10. Engine 10 is depicted as a two-stroke dual-fuel engine. However, other types of engines, such as four-stroke engines may be used as well. Engine 10 may include an engine block 12 that a least partially defines a plurality of cylinders 16 (only one shown), each having an associated cylinder head 20. A cylinder liner 18 may be disposed within each engine cylinder 16, and cylinder head 20 may close off an end of liner 18. A piston 24 may be slidably disposed within each cylinder liner 18. Each cylinder liner 18, cylinder head 20, and piston 24 may together define a combustion chamber 22 that receives fuel from a fuel system 14 mounted to engine 10. It is contemplated that engine 10 may include any number of engine cylinders 16 with corresponding combustion chambers 22.

Within engine cylinder liner 18, piston 24 may be configured to reciprocate between a bottom-dead-center (BDC) or lower-most position and a top-dead-center (TDC) or upper-most position. In particular, piston 24 may be an assembly that includes a piston crown 26 pivotally connected to rod 28, so that a sliding motion of each piston 24 within liner 18 result in a rotation of crankshaft 30. Similarly, a rotation of crankshaft 30 may result is a sliding motion of piston 24. As crankshaft 30 rotates through about 180 degrees, piston crown 26 and connected rod 28 may move through one full stroke between BDC and TDC. Engine 10, being a two-stroke engine, may have a complete cycle that includes a power/exhaust/intake stroke (TDC to BDC) and an intake/compression stroke (BDC to TDC).

During a final phase of the power/exhaust/intake stroke described above, air may be drawn into combustion chamber 22 via one or more gas exchange ports (e.g., air intake ports) 32 located within a sidewall of cylinder liner 18. In particular, as piston 24 moves downward within liner 18, a position will eventually be reached at which air intake ports 32 are no longer blocked by piston 24 and instead are fluidly communicated with combustion chamber 22. When air intake ports 32 are in fluid communication with combustion chamber 22 and a pressure of air at air intake ports 32 is greater than a pressure with combustion chamber 22, air will pass through air intake ports 32 into combustion chamber 22. It is contemplated that gaseous fuel (e.g., methane or natural gas) may be introduced into combustion chamber 22 (radially injected) through at least one of air intake ports 32. The gaseous fuel may mix with the air to form a fuel/air mixture within combustion chamber 22.

Eventually, piston 24 will start an upward movement that blocks air intake ports 32 and compresses the air/fuel mixture. As the air/fuel mixture within combustion chamber 22 compresses, a temperature of the mixture may increase. At a point when piston 24 is near TDC, a liquid fuel (e.g. diesel or other petroleum-based liquid fuel) may be injected into combustion chamber 22 via a liquid fuel injector 36.

The liquid fuel may be ignited by the hot air/fuel mixture, causing combustion of both types of fuel and resulting in a release of chemical energy in the form of temperature and pressure spikes within combustion chamber 22. During a first phase of the power/exhaust/intake stroke, the pressure spike within combustion chamber 22 may force piston 24 downward, thereby imparting mechanical power to crankshaft 30. At a particular point during this downward travel, one or more gas exchange ports (e.g., exhaust ports) 34 located within cylinder head 20 may open to allow pressurized exhaust within combustion chamber 22 to exit and the cycle will restart.

Liquid fuel injector 36 may be positioned inside cylinder head 20 and configured to inject liquid fuel into a top of combustion chamber 22 by releasing fuel axially towards an interior of cylinder liner 18 in a generally cone-shaped pattern. Liquid fuel injector 36 may be configured to cyclically inject a fixed amount of liquid fuel, for example, depending on a current engine speed and/or load. In one embodiment, engine 10 may be arranged to run on liquid fuel injections alone or a smaller amount of liquid fuel mixed with a gaseous fuel. Gaseous fuel may be injected through air intake port 32 via any number of gaseous supply lines 37 that are connected to gaseous fuel injectors 38. The gaseous fuel may be injected radially into combustion chamber 22 through a corresponding air intake port 32 after the air intake port 23 may be opened by movement of piston 24.

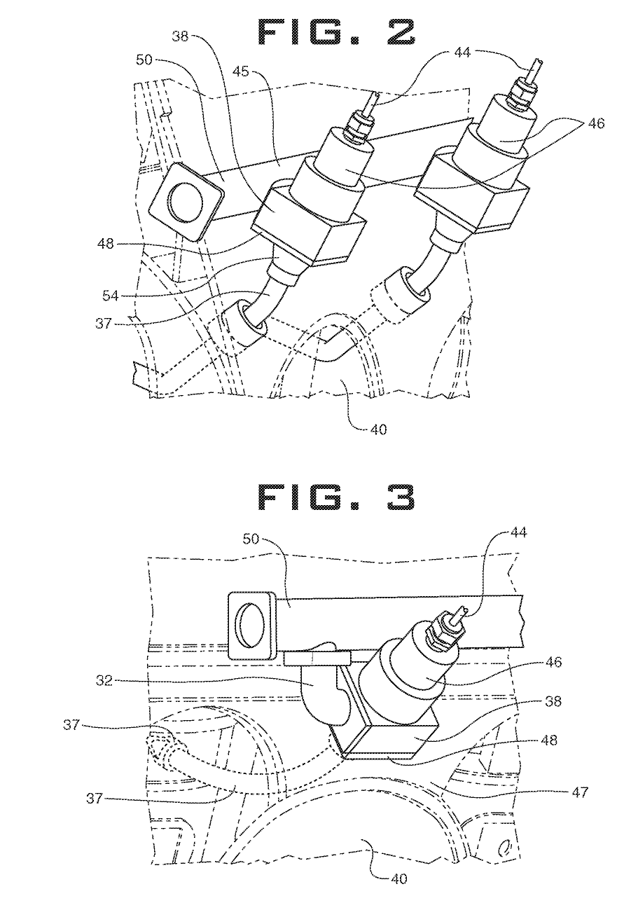

The gaseous fuel injector 38 may be positioned outside an airbox 40. The airbox 40 serves as a source of air to be introduced to at least one cylinder 16 during the combustion process. An inlet end 41 of the gaseous fuel supply line 37 connects to the gaseous fuel injector 38 and an outlet end 43 of the gaseous fuel supply line 37 connects to and seals the cylinder liner 18. The outlet end 43 is in direct communication with one of the air intake ports 32 of an adjacent engine cylinder 16. A non-return valve 42 is positioned within the gaseous fuel supply line 37. The non-return valve is distally located from the inlet end 41 of the gaseous fuel supply line 37 to prevent backflow of exhaust gas into the gas manifold 45. Alternatively, the non-return valve 42 may be distally located from the outlet end 43 of the gaseous fuel supply line 37 to prevent backflow of exhaust gas into the gas manifold 45 (not shown). Further, the gaseous fuel injector 38 as depicted in FIG. 1 is mounted directly to a gas manifold 45. This provides an additional advantage of isolating the gaseous fuel injector 38 from engine vibration. The gas manifold 45 may be a common pipe 50 as shown in FIG. 2. Alternatively, the gas manifold 45 may be a plurality of pipes (not shown). It is noted that the gaseous fuel injector 38 can be mounted on the gas manifold 45 between the gas manifold 45 and the engine crankcase 47. Alternatively, the gaseous fuel injector 38 may be mounted on the gas manifold 45 outbound of the engine crankcase 47.

Engine 10, utilizing fuel system 14, may consume two types of fuels when it is run as a dual-fuel engine. It is contemplated that the gaseous fuel may produce between 40% and 85% of a total energy output of engine 10. For example, the gaseous fuel may produce between 60% and 65% of the total output, with the liquid fuel producing the remaining 35-40%. In any case, the liquid fuel can act as an ignition source such that a smaller amount will be necessary than what is needed for engine 10 if it were running on only liquid fuel.

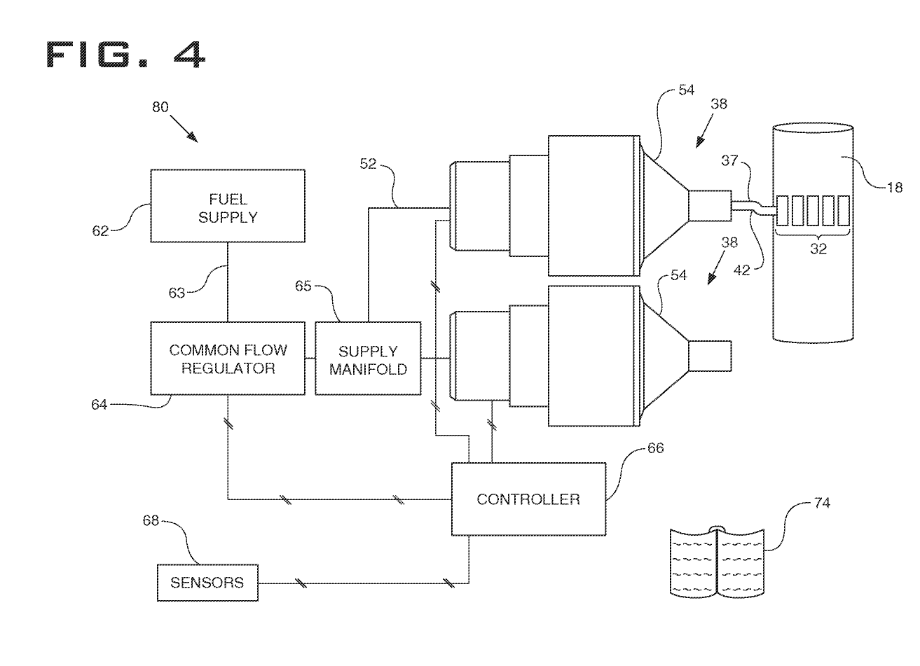

FIG. 2 illustrates the gaseous fuel injector 38 mounted directly to the gas manifold 45 outbound of the engine crankcase 37. This may provide ease of mounting for other valve options. The gaseous fuel injector 38 may be connected at an opposing external end to power and control components of the fuel system 14. These components may include, among other things, wiring 44 to supply electrical power, and a means to convert the electrical power into mechanical power, such as a solenoid 46. Mounting hardware 48 may include a mounting plate and bolts (not shown) to mount gaseous fuel injector 38 directly to the cylinder liner 18, such that the gaseous fuel injector 38 is positioned at air intake port 32. Fuel system 14 may further include (i.e., in addition to liquid fuel injector 36 and gaseous fuel injector 38) at least one fuel supply line 52 connected to gaseous fuel injector 38. Supply line 52 may be positioned inside airbox 40 and may be connected to a fuel supply 62 (shown schematically in FIG. 4) at a distal end. Fuel supply 62 may represent a fuel tank or other container configured to serve as a fuel reservoir. It is contemplated that fuel system 14 may further include a supply manifold 65 (shown schematically in FIG. 4), located within or outside of airbox 40, that supplies gaseous fuel to multiple gaseous fuel injectors 38, if desired. Supply manifold 65 may be connected to a common flow regulator 64 (shown in FIG. 4) for controlling the flow of fuel into supply manifold 65.

FIG. 3 illustrates an alternative mounting arrangement of the gaseous fuel injector 38. The gaseous fuel injector 38 may be positioned outside of the airbox 40 and mounted directly to the engine crankcase 47. This may provide isolation of the gaseous fuel injector 38 from engine vibration. Moreover, the gaseous fuel injector 38 attached to the engine crankcase 47, as illustrated in FIG. 3, is positioned in line with the air intake port 32. This may minimize dead volume within the gaseous supply line 37 that feeds gas at the intake port 32.

FIG. 4 schematically illustrates the components of an exemplary fuel system retrofit kit 80 for engine 10. Retrofit kit 80 may include the components necessary to convert an existing single-fuel (e.g., diesel-only) engine into the dual-fuel engine that has been described above. Retrofit kit 80 may include, among other things, one or more gaseous fuel injectors 38, each including a nozzle 54. One or more multiple gaseous fuel injectors 38 may be associated with each cylinder 16. A fuel supply 62, a common fuel supply line 63, a common flow regulator 64, a supply manifold 65, and individual fuel supply lines 52 may be included in retrofit kit 80. Control components, including controller 66 and sensors 68, may be included in kit 80. It is contemplated that sensors 68 may represent one or more performance sensors (e.g., temperature, pressure, and/or knock sensors) configured to generate a signal indicative of a performance condition of the engine after conversion of the engine to run on two different fuels and relay that signal to controller 66. Controller 66 may be capable of further communicating with common flow regulator 64, and/or an existing liquid fuel injector.

Retrofit kit 80 may additionally include a set of instructions 74 for properly installing the components of kit 80. One of ordinary skill in the art would recognize that retrofit kit 80 of FIG. 4 represents an exemplary kit for converting a single fuel engine and additional and/or different combinations of components may be necessary to complete the conversion of the given engine.

### INDUSTRIAL APPLICABILITY

As an application of the present disclosure, a fuel system 14 for an internal combustion engine 10 is used to provide fuel. Typically, in fuel systems, dual-fuel engines are used to provide injections of low-cost gaseous fuel into clear air that enters through intake ports of at least one cylinder and is ignited with liquid fuel that is injected during each combustion cycle. Generally, under normal conditions, combustion of the gaseous fuel mixture may result in reduction of harmful emissions. The gaseous fuel injector 38 is used to introduce fuel into the engine 10 via a gaseous supply line 37.

The fuel system for an internal engine 10 having at least one cylinder 16 includes a liquid fuel injector 36 configured to inject liquid fuel into the at least one cylinder 16; a gaseous fuel injector 38 having a nozzle 54 to configured to inject gas in at least one cylinder 16, wherein the gaseous fuel injector 38 is positioned outside of an airbox 40 of at least one cylinder 16.

The gaseous fuel injector 38 is located outside of the airbox 40, thus providing ease of access for service and maintenance.

In the embodiment shown in FIG. 1, the gaseous supply line 37 includes an outlet end 43 and opposing inlet end 41, as illustrated in FIG. 2. The outlet end 43 includes a nozzle 54 that is attached to the gaseous fuel injector 38. By use of this gaseous supply line 37, the outlet end 43 is located adjacent to the air intake ports 32 on the cylinder liner 18, thus positioning the gaseous fuel injector 38 and its nozzle 54 outside of the airbox 40 and away from the cylinder liner 18. Since the nozzle 54 is a significant distance away from the cylinder liner 18, high temperatures and pressures during combustion may be avoided. This may result is a more reliable device.

Other aspects may be obtained from a study of the drawings, the specification, and the appended claims.

What is claimed is:

1. A fuel system for an engine having at least one cylinder, comprising:
a liquid fuel injector configured to inject liquid fuel into the at least one cylinder; and
a gaseous fuel injector having a nozzle configured to inject gaseous fuel into the at least one cylinder, wherein the gaseous fuel injector is positioned outside an airbox associated with the at least one cylinder.

2. The fuel system of claim 1, wherein the at least one cylinder is associated with a two-stroke engine, the at least one cylinder having an intake port located on a circumference of the cylinder and provides an opening between the airbox and the least one cylinder.

3. The fuel system of claim 1, further comprising a gaseous supply line having an outlet end and an inlet end, wherein the inlet end connects to the gaseous fuel injector and the outlet end connects to the at least one cylinder via an intake port.

4. The fuel system of claim 1, wherein the airbox serves as a source of air to be introduced into the at least one cylinder during engine combustion.

5. The fuel system claim 1, further comprising a gas manifold mounted outside of the airbox oriented in an axial direction along an engine crankcase.

6. The fuel system claim 1, further comprising a non-return valve positioned in the gas supply line, distally from at one of: (i) the inlet end or (ii) the outlet end.

7. The fuel system of claim 5, wherein the gaseous fuel injector is attached to the gas manifold.

8. The fuel system of claim 1, wherein the gaseous fuel injector is attached to an engine crankcase.

9. The fuel system of claim 5, wherein the gas manifold is configured with a common pipe to the gaseous fuel injector.

10. The fuel system of claim 5, wherein the gas manifold is configured with a Plurality of pipes, each pipe associated with a corresponding gaseous fuel injector.

11. A fuel system for an engine having at least one cylinder, comprising a gaseous fuel injector positioned outside an airbox associated with the at least one cylinder.

12. The fuel system of claim 11, further comprising a gaseous supply line having an outlet end and an inlet end, wherein the outlet end connects to the gaseous fuel injector and the inlet end connects to the at least one cylinder via an intake port.

13. The fuel system of claim 11, wherein the airbox serves as a source of air to be introduced into the at least one cylinder during engine combustion.

14. The fuel system of claim 11, further comprising a gas manifold mounted outside of the airbox oriented in an axial direction along an engine crankcase.

15. The fuel system of claim 14, wherein the gaseous fuel injector is attached to the gas manifold.

16. The fuel system of claim 15, wherein the gaseous fuel injector is attached to the gas manifold at one of (i) between the gas manifold and the engine crankcase and (ii) outbound from the engine crankcase.

17. The fuel system of claim 11, wherein the gaseous fuel injector is attached to an engine crankcase.

18. The fuel system of claim 17, wherein the gaseous fuel injector attached to an engine crankcase is positioned in line with the intake port.

19. The fuel system of claim 14, wherein the gas manifold is configured with a common pipe to the gaseous fuel injector.

20. The fuel system of claim 14, wherein the gaseous manifold is configured with a plurality of pipes, each pipe associated with a corresponding gaseous fuel injector.
